(19) United States
(12) Patent Application Publication
(10) Pub. No.: US 2006/0096118 A1
(43) Pub. Date: May 11, 2006

(54) Hot-air blower/dryer with side-by-side motors, and an exhaust end cap

(76) Inventors: John O. Ward III, Osseo, WI (US); Gary A. Myhre, Osseo, WI (US)

Correspondence Address: FISHER, CHRISTEN & SABOL, 1725 K STREET, N.W., SUITE 1108, WASHINGTON, DC, 20006, US

(21) Appl. No.: 10/981,553

(22) Filed: Nov. 5, 2004

(51) Int. Cl. F26B 3/00; F26B 21/06

(52) U.S. Cl. 34/487; 34/72

(57) ABSTRACT

A hot-air blower/dryer which includes two inline hot-air blowers positioned side-by-side with one another. Each of the inline hot-air blowers has a housing in which are located, in line, a motor, a fan and a heat element (coil). Each housing has a nozzle passageway running from it. The two nozzle passageways merge with an exit passageway to from an exhaust/end cap.

### BACKGROUND OF THE INVENTION

1. Field of the Invention

The invention relates to an air-blowing tool. In particular, the invention relates to a hot-air blower/dryer with side-by-side units, each of a motor and fan means, and an exhaust end cap, with the two caps forming an entity having a sole exhaust entity.

2. Background Art

Electrically powered hot-air blowers have found widespread use, ranging from handheld household devices useful to dry wet hair, to large units that find industrial application. Typically 110 to 220 VAC is applied across a resistive Nichrome heating element to produce heat. An electric fan then blows heated air from the heating element in a desired direction, e.g., toward one's head in a household hair dryer type device.

U.S. Pat. No. 2,713,627 discloses a hair blowing device for blowing and removing loose hair from a barber's customer, for example. Such device involves an electric motor and a fan in a housing that is open at the end where the fan is located. Air is drawn into the housing just before the fan via holes in the side of the housing. The open end of the housing has an open cup-shaped member connected thereto. The open cup-shaped member has a reducer nozzle through which the air exits. One embodiment of the blowing device is its conversion into an air dryer by including a heating element (coil) in the housing between the fan and the air exit passageway of the nozzle.

U.S. Pat. No. 3,261,107 discloses a portable, compact hair dryer. Such hair dryer includes the motor, the heater and the fan as a unit plus the flexible hose and the cap. The hose is connected to the hair dryer hot-air outlet and is collapsible for storage.

U.S. Pat. No. 6,640,049 discloses an ion emitting hot-air blower. A surplus of preferably positive ions are thermally emitted by a device, such as, a hair dryer, that includes the heating element disposed upstream from the electrically conductive grid. The rectifier circuit is coupled between the heating element and the grid and establishes the electric field therebetween. Polarity of the field affects ion content downstream from the grid. The fan assembly blows heated air and ions toward the conductive grid, whereat ions of one polarity are substantially removed. The ion sensor and feedback circuit may be coupled to the device to sense and control net ion content adjacent the sensor. In a hair dryer device, a net surplus of positive ions promotes grooming and rapid drying of a user's hair.

U.S. Pat. No. 2,353,247 discloses an electric space heater. Such space heater includes, in the elongated housing, the electric motor driving the fan (impeller), the baffle and the heating element.

U.S. Pat. No. 6,560,892 discloses an air blowing tool for blowing hot air onto heat-shrinkable packing material. The connecting pipe is connected on one end with the hot-air blower, and on the other, with the hot-air blowing head. The air blowing head includes the inner wall and the outer wall. The annular passage is defined between the inner and outer walls. The inner wall encloses and defines the heating space for accommodating the package to be heated. The annular outlet is defined in the inner wall. The annular outlet communicates with the annular passage and with the heating space.

The online article “Heat guns”, diydata, four pages, downloaded on Jul. 19, 2004, www.diydata.com/tool/heat_gun/heat_gun.htm, discusses heat guns, how they work, temperature settings, etc. (The fourth page recites copyright of 2000 to 2004). In the typical heat gun, air is pulled into the body of the tool by a fan (driven by an electric motor), driven across an electric heating element and pushed out through a nozzle. The wattage of a heat gun is typically from 1000 W to 2000 W, and the temperature setting must be at least 500° C. if the purpose of the heat gun is to strip paint. A temperature of 30° to 130° C. is used to dry paint or varnish. Some heat guns have only one heat setting and one fan speed. Other heat guns have two or three settings or even fully variable adjustment within a range, together with a choice of two, three or variable speeds of air flow. Various types of nozzles to fit on the air-exit end of the heat gun are described and shown. For example, there is a reducer nozzle to concentrate the heated air flow.

U.S. Pat. No. 2,898,691 discloses an animal dryer that involves the cabinet into which the newly washed animal is placed. Warm air is circulated about the animal to dry it. The warm-air blower is mounted on the cabinet and the blower is powered by the electric motor. The air is pulled from outside of the cabinet through the blower and into the cabinet. A portion of the cabinet is usually a wire grid.

R. C. Steele, Animal Dryers, (Jan. 4, 1997), page 41, is an advertisement page that displays several dryers. One type of dryer shown is the so-called Double K Dryer which is employed as a cage and table dryer. The Double K Dryer includes a totally enclosed motor, a heavy-duty heating element with a built-in thermostat, and a safety fuse. The motor adjusts from 70° to approximately 140° (1580 watts). The Air Force Commander Dryer has two drying speeds, and legs that allow it to stand vertically or horizontally. The Challengair Stand Dryer has variable air and temperature control. The Deluxe Hi-Velocity Stand Dryer has three heat settings, plus “air” only setting. The Hi-Velocity Cage & Table Dryer also has three heat settings and an “air” only setting. The Super Duck Dryer that is removably mounted on a stand has six different settings for temperature and velocity

U.S. Pat. No. 3,596,636 discloses a drying enclosure for pets and other animals. Such enclosure has an air inlet conduit connection for entry of the air for drying the animal and an opening for fitting around the neck of the animal. The hair dryer on similar apparatus is connected to the air inlet conduit connection.

U.S. Pat. No. 4,718,375 discloses a drying apparatus for horses and other animals. The drying apparatus involves an inflatable jacket that fits around the trunk (main body portion) of the animal. The air blower delivers warm air via the flexible air tube to the inflatable jacket. The air blower is said to be conventional. The flexible air tube is connected to the supply holes in the inflatable jacket. There are air vent-holes in the inflatable jacket.

U.S. Design Pat. No. DES 427,388 shows the ornamental design of a livestock blow dryer. Such livestock blow dryer has a single elongated-shape barrel outer shell on which is mounted four support legs and has a handgrip on the top surface thereof. The front end of the outer shell has a cone shaped cap with a flexible outlet hose mounted at the apex thereof. The back end of the outer shell contains a screen. Just in from the screen is a large slot in which a removable air filter is positioned.

The advertisement (one page; apparently dated 2001) for Air Express III of Sullivan Supply, Inc. is for the livestock blow dryer of U.S. Design Pat. No. DES 427,388.

The online advertisement (one page, downloaded Jun. 11, 2001) at www.sullivansupply.com/airexpress.asp describes the Air Express III livestock blow dryer.

All of the above-described prior art devices/apparatus only have one (inline) unit of a motor, fan and heat coil. These single inline units have the disadvantage of providing inadequate airflow and relatively short motor lives.

Ametek, Lamb Electric Division, markets electric motor model number 119489-00, that is described as a thru-flow vacuum motor. The motor has a tapered fan system with the fan blades affixed to one end of the rotatable control shaft of the motor. The product bulletin, Ametek, Lamb Electric, motor model number 119489-00, states that such motors are designed to permit the vacuumed air to pass over the electrical winding to cool it.

Electric Cleaner Company, Inc., Osseo, Wis. 54758, has marketed an inline hot-air blower/dryer that contains the Ametek/Lamb Electric thru-flow vacuum motor model number 119489-00 in a housing, that is open (apertures) at each end for air flow therethrough. (Such Blower/dryer does not have a heat coil.) The passage of the intake air over/thru the motor (electrical winding) warms/heats the air that passes on out the exit aperture. While this single inline unit is a good hot-air blower/dryer, it has the disadvantage of providing inadequate airflow and a relatively short motor life.

### BROAD DESCRIPTION OF THE INVENTION

An object of the invention is to overcome the disadvantages and problems of prior art hot-air blower/dryers. For example, lack of sufficient airflow and relatively short motor lives are disadvantages of existing inline units. The advantages of this side-by-side units arrangement includes the maxim CFMs produced by the bilateral airflow. Having the motors working side by side instead of inline both creates fifty percent more airflow, and creates longer motor life over an inline unit.

Other objects and advantages of the invention are set out herein or are obvious herefrom to one skilled in the art.

The subject invention includes a unit that has side-by-side inline hot-air (or warm-air) blowers. The invention unit has utility both as an animal blower/dryer and as an industrial blower. The invention also involves the exhaust end cap for the invention unit. That is, the invention involves a combination portable heater and blower, aligned side-by-side with the two corresponding motors aligned side-by-side, for animal grooming, for drying of grain, and for like farm applications. The subject invention may be described as a professional grade, high velocity hot blower/dryer.

The invention hot-air blower/dryer achieves the objects of the inventions.

The invention includes a hot-air blower/dryer that includes:

(a) a first inline hot-air blower, and

(b) a second inline hot-air blower.

The first inline hot-air blower and the second inline hot-air blower are positioned side-by-side, preferably in parallel alignment and, more preferably, horizontally in parallel alignment. Each inline hot-air blower has, in a housing, a motor and fan means. The inline blower preferably provides air that may be from room temperature to about 124° F. The fan means can be separate from the motor or incorporate as part of the motor.

Preferably the first inline hot-air blower includes a first housing having therein inline, a first motor and a first fan rotatably attached to and powered by the first motor, with the first housing having an entrance aperture and an exit aperture. Preferably the second inline hot-air blower includes a second housing, having therein inline, a second motor and a first fan rotatably attached to and powered by the second motor, with the second housing having an entrance aperture and an exit aperture. Preferably there is an exhaust end cap that includes an exit passageway, a first entrance passageway in communication with the exit passageway and with the exit aperture of the first housing, and a second entrance passageway in communication with exit passageway and the exit aperture of the second housing. More preferably the three passageways of the exhaust end cap are arranged so as to form a Y (shape).

Preferably meshes are positioned over the entrances of the first and second housing.

Preferably the first inline hot-air blower and the second inline hot-air blower are mounted horizontally on a support. For example, the support has four casters or can have legs or is two stands.

Preferably the exit passageway of the exhaust end cap has an exit end, and the exit end is adapted for attachment of a hose thereto.

Very preferably, in the invention hot-air blower/dryer, the air is sucked in through the intake end of the blower/dryer machine and through a 2-inch (preferable) orifice on the backside of the motor (motor casing). A fan assembly mounted inside the motor (motor casing) creates the suction and exhaust. The air then exits through the exhaust side of the motor through a 1½ inch (preferable) opening and passes by the motor brushes, which warm while the motor is running. The air then exits the unit through a 1½ inch (preferable) hose and through a blower tip with a ½ inch (preferable) opening. The hot (motor casing) air is created with the combination of the reduction in airflow and the heat of the motor and motor brushes (windings).

The invention also includes an exhaust end cap, useful for example with the hot-air blower/dryer of the invention. The exhaust end cap has an exit passageway, a first entrance passageway having an entrance end and in communication with the exit passageway, a second entrance passageway having an entrance end in communication with the exit passageway, a first cap portion surrounding and extending away from the entrance end of the first entrance passageway, and a second cap portion and extending away from the entrance end of the second entrance passageway. Preferably the three passageways of the exhaust end cap are arranged so as to from a Y (shape).

Preferably the side of first cap portion away from the entrance end of the first entrance passageway has a concave shape, and the side of second cap portion away from the entrance end of the second entrance passageway has a concave shape. Preferably the exit passageway of the exhaust end cap has an exit end, and the exit end is adapted for attachment of a hot-air hose thereto.

### BRIEF DESCRIPTION OF THE DRAWINGS

In the drawings:

FIG. 1 is a view of the hot-air blower/dryer with side-by-side motors including the first and second housings, the intake caps on the first and second housings, the nozzles running from the first and second motors, and an exhaust/end cap, in which one is looking somewhat upwards at the unit;

FIG. 2 is a top elevational view of the hot-air blower/dryer including the supports for the first and second housings;

FIG. 3 is a cross-sectional bottom view of the hot-air blower/dryer including the supports for the first and second housings;

FIG. 4 is a cross-sectional side view of the first and second housings, the intake caps on the first and second housings, the nozzles running from the first and second motors, and an exhaust/end cap of the hot-air blower/dryer;

FIG. 5 is a cross-sectional side view of one of the housings of the hot-air blower/dryer including one of the nozzles running from one of the motors, the exhaust/end cap and the intake cap;

FIG. 6 is a wiring diagram for the hot-air blower/dryer including the first and second switches;

FIG. 7 is a partial cross-sectional side view of the most preferred hot-air blower/dryer including cross-sectional side views of the first and second housings containing, respectively, the first and second motors and first and second fans attached to and powered by the first and second motors;

FIG. 8 is a partial cross-sectional view of the motor of the hot-air blower/dryer of FIG. 7;

FIG. 9 is a partial cross-sectional side view of another embodiment of the hot-air blower/dryer; and

FIG. 10 is a cross-sectional side view of the end of the hose that is removably attachable to the hot-air exit of the exhaust end cap.

### DETAILED DESCRIPTION OF THE INVENTION

The invention involves an electrically powered hot-air blower, typically operated with 110 to 220 VAC. A fan or fan component blows inlet air across and/or through the motor, whereby the air is warmed/heated, and on out of the blower/dryer apparatus in a combined manner.

The hot-air blower/dryer unit of the invention achieves the objects and advantages of the invention.

Assembly Instructions for a preferred embodiment of the subject hot-air blower/dryer unit are as follows:

1. Apply two body gaskets to the inside of the body, and apply four cover gaskets to the end caps.

2. Regarding installing the two motors, with the switch holes up, set one motor in each housing upside down with the two wires from each motor running along the side of the motor, back towards the bottom of the motor.

3. Apply the two motor stops to each housing using two tapping screws, each to hold the motors in place.

4. Insert the service cord into the pre-drilled power cord hole.

5. Insert two cord grommets into the pre-drilled cord holes in the center of the unit.

6. Insert the short cord between the motor housing where grommets were just inserted.

7. Insert two power switches into pre-drilled switch holes.

8. Connect one of the wires from the short cord to the wire from the motor. Connect the other two wires together.

9. Continue wiring the unit using an enclosed wiring diagram.

10. Apply the handle to the top of the unit using four bolts.

11. Apply the exhaust cap to the exhaust end to the unit using three self-tapping screws on each housing.

12. Apply an intake cap to each housing on the intake side using three self-tapping screws.

The method of operation includes a fan pulling air into the body of the hot-air blower/dryer, preferably across and/or through the motor, and out through a nozzle.

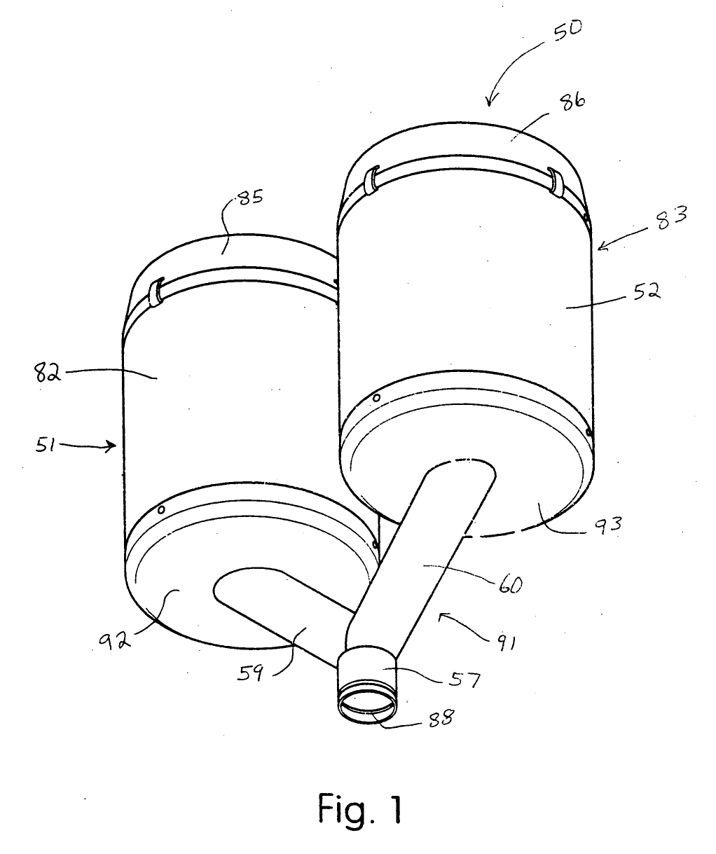

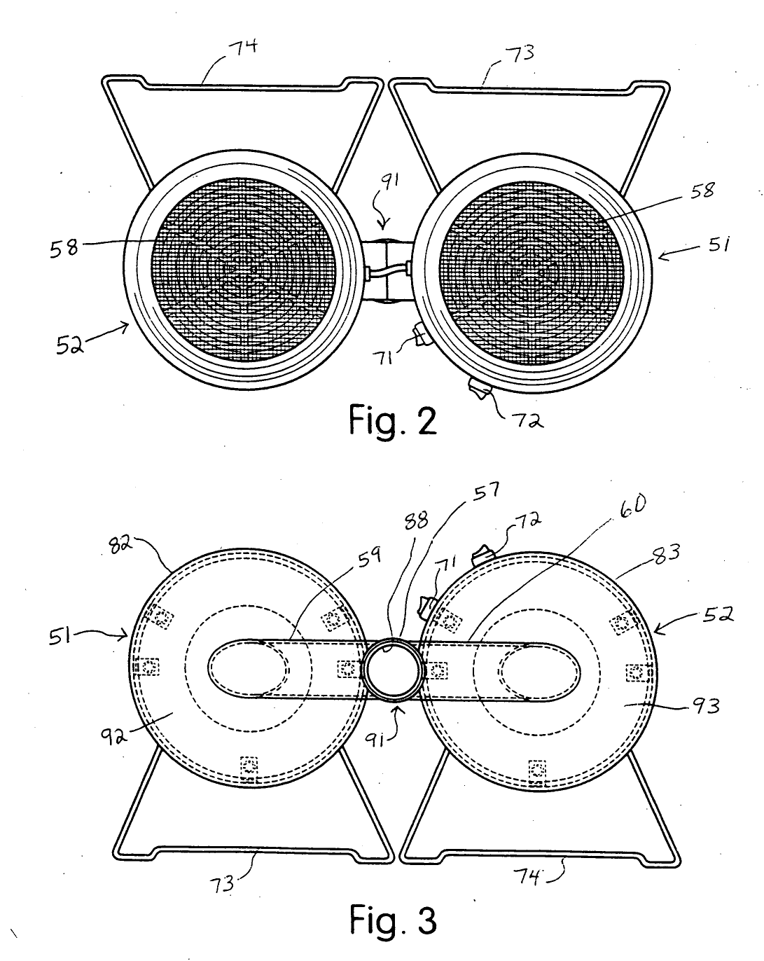

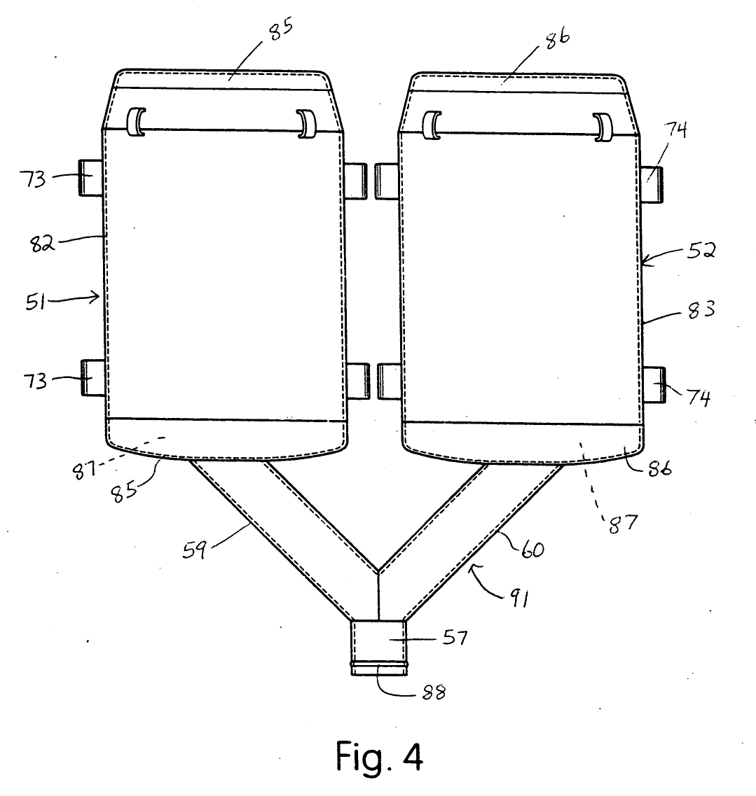

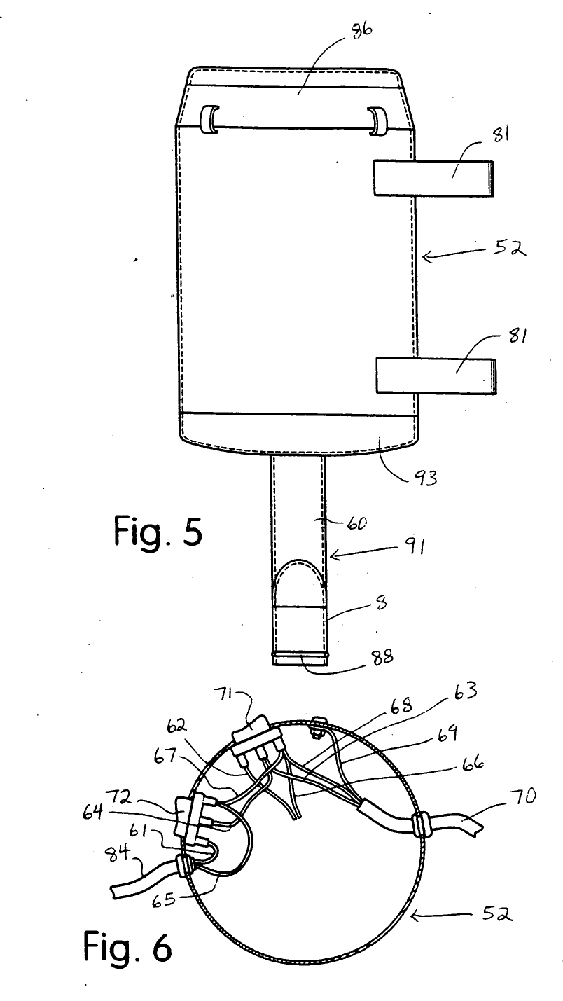

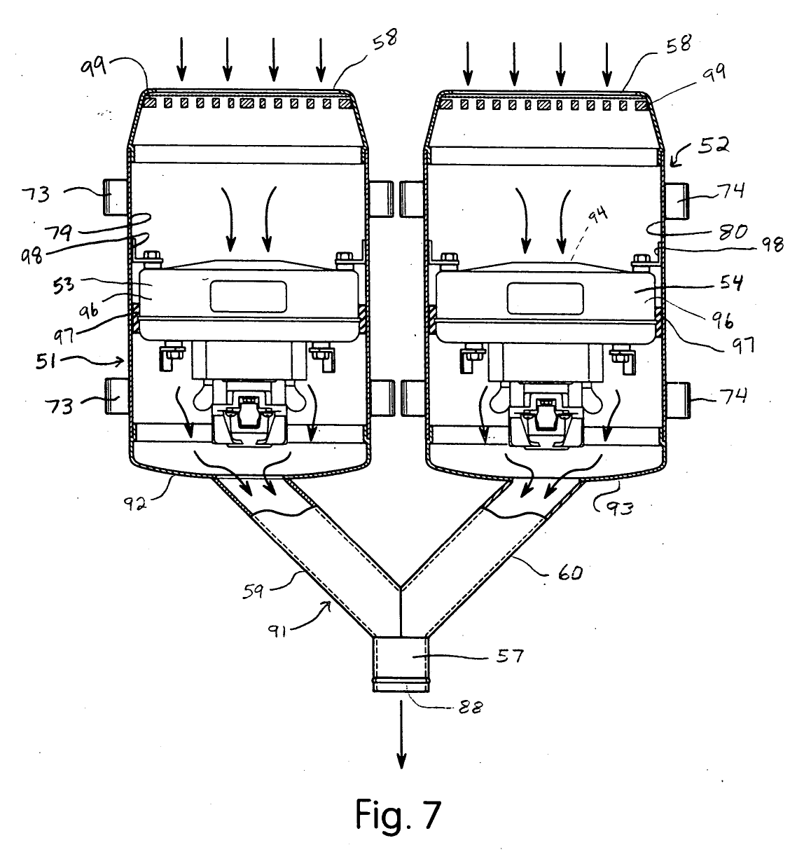

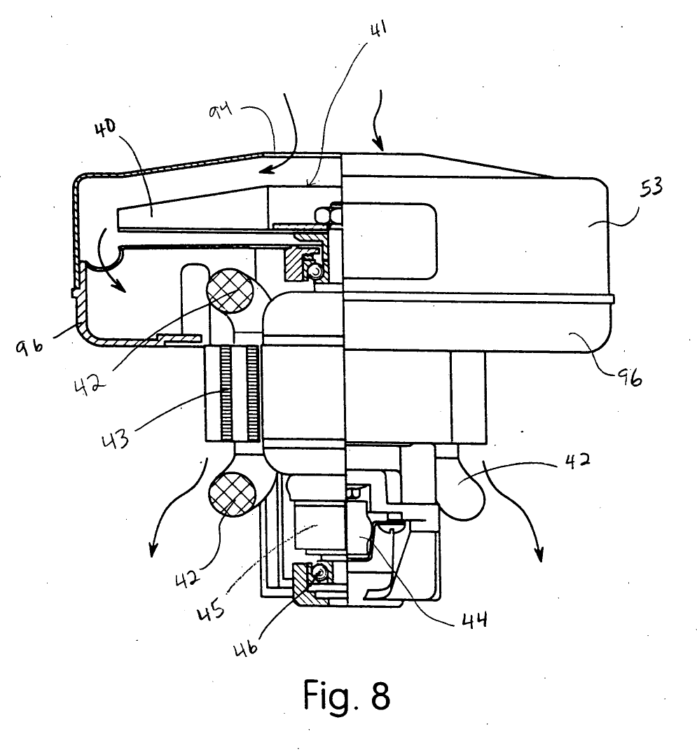

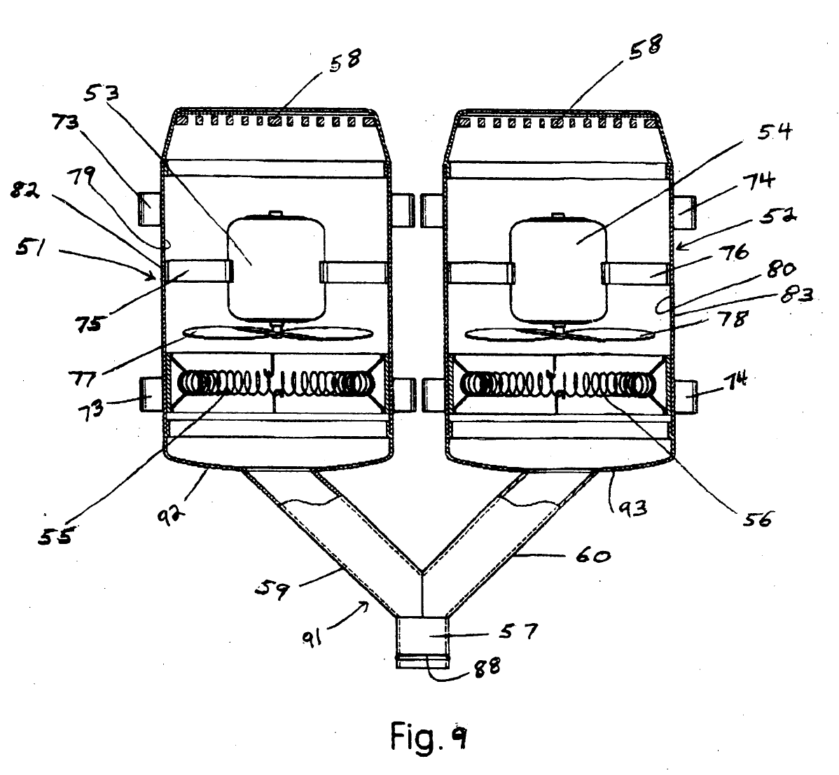

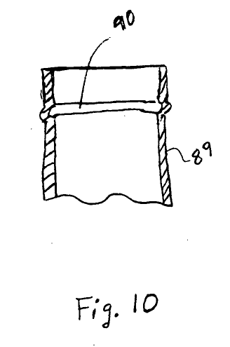

As shown in FIGS. 1 to 8 and 10, the most preferred embodiment of the invention involves a hot-air blower/dryer (50) that includes side-by-side motors, that is, a first motor (53) and a second motor (54). Each of the two side-by-side motors (53 and 54) are secured within a housing (51 and 52). That is, the first housing (51) has an inner wall (79) and an outer wall (82). Likewise, the second housing (52) has an inner wall (80) and an outer wall (83). Supports (98) secure the first motor (53) to the inner wall (79) of the first housing (51), and the second motor (54) to the inner wall (80) of the second housing (52). There are gaskets (97) for motors (53, 54). A blade (40) is rotatably attached to and powered by the first motor (53), forming a fan (41). Likewise, a blade (40) is rotatably attached to and powered by the second motor (54), forming a fan (41).

Mesh (58) and screens (99) are located in air inlet apertures (58).

A nozzle passageway (59) runs from the first housing (51). A nozzle passageway (60) also runs from the second housing (52). The two nozzles passageways (59 and 60) merge into one, onto which is attached an exhaust/end cap (57).

In the first housing (51), the first motor (53), is located with the first fan (40) towards the air-inlet aperture (58). In the second housing (52), the second motor 54 is located with the second fan (40) towards the air-inlet aperture 58. The fan (40) pulls air in through the air-inlet aperture 58. The fan (40) pulls air in through the air-inlet aperture (58). The air flows into the fan (40) space through the opening (94) and on into the motor region through the opening (95). The fan blades (41) provide the means to move the hot-air blower/dryer (50). The motors (53, 54) has copper windings (42), spacer blocks (43), bushings (44), armatures (45) and bearings (46). The air is warmed/heated from the bushings as it cools them and passes through the motor. The heated air then is pushed out of the double end cap [and into the optional hose (89)].

In each housing (51 and 52), the method of operation includes fan (40) pulling air into the body of the hot blower/dryer unit and driving it across and through a motor (53 and 54) and out through a nozzle passageway (59 and 60). The air is pulled into both the first housing (51) and the second housing (52) through mesh (58) positioned across the top of each of the housing. An intake cap (85) is secured onto the air intake end of the first housing (51). Likewise, an intake cap (86) is secured onto the air intake end of the second housing (52).

Wiring connects two switches (71 and 72) that are attached to the inner wall (80) of the second housing (52), and both of the motors (53 and 54) as follows: a wire (61) runs from the left motor to the off side of the second switch (72); a wire (62) runs from the right motor to the off side of the first switch (71); a wire (63) runs from the power cord to the first switch (71); a jumper wire (64) runs between the first and second switches (71 and 72); a wire (65) runs from the left motor to the on side of the second switch (72); a wire (66) runs from the right motor to the on side of the first switch (71); a jumper wire (67) runs between the first switch (71) and the second switch (72) to the power light; a power cord (68) runs to the light on the second switch (72); a ground wire (69) runs to the inner wall (80) of the second housing (52); and a service cord (70) is present. A cord (84) runs between the first motor (53) and the second motor (54) encasing the wires running therebetween.

A support (73) for the first housing (51) is secured to the exterior of the outer wall (82) of the first housing. Likewise, a support (74) for the second housing (52) is secured to the exterior of the outer wall (83) of the second housing. Stands (81) extend from the outer wall (83) of the second housing.

Intake caps 85 and 86 are cup-shaped, with each having an internal (concave) cavity 87. Nozzle passageway (88) serves as the exhaust exit for the two inline hot-air blowers/dryers. Groove 88, located in nozzle passageway (88), serves as means to removably affix hot-air hose (89) which has raised (rim)portion (90) that fits into groove (88) when the end of hose (89) is inserted into passageway (88).

Any type of nozzle (not shown) can be affixed to the other end of hose (89). Also, hose (89) can be affixed to animal drying cages, drying blankets, etc., of the types known in the art, or to drying containers and the like for grain, etc. The temperature range for the hot air exiting the invention hot-air blower/dryer is usually in the range of room temperature to 124° F. for animal drying/grooming, in the range of room temperature to 124° F. for the drying of grain and other appropriate food stuffs, and in the range of room temperature to 124° F. depending upon the requirements of the particular industrial application.

The invention hot-air blower/dryer can have one, two, three or more temperature settings for air temperature and for air velocity, or can have variable air temperature control and variable air velocity control.

Housings (51 and 52) preferably are cylincrical or tubular, but can have any suitable cross-sectional shape.

Housings (51 and 52) are preferably aligned parallel to each other, however they can be at slight angles to each other. Housings (51 and 52) preferably are positioned in the horizontal plane, but can be located in any plane to the vertical.

If desired one or more inline hot-air blowers/dryer can be added to the minimum of two required by the inventions.

In each of the inline hot-air blowers/dryers, the motor and the associated are preferably axially aligned.

The two inline hot-air blower/dryers are mounted on a support. Such support and items on it is usually portable/movable as a unit by one person. The support can have stands, e.g., as shown in FIG. 3, or can have wheels or castors.

Inward of the screens on the cool air intakes, and before the motor, a removable air filters can be used.

The invention hot-air blower/dryer, having side-by-side inline hot-air blowers provides sufficient airflow to achieve the invention advantages and objects, as opposed to the known prior art hot-air blowers/dryers that have only one hot-air blower. The invention hot-air blower/dryer is very effective as an animal blower/dryer, as an industrial blower and a farm application blower. The invention hot-air blower/dryer also has relatively longer motor lives than the known prior art hot-air blowers/dryers.

Another embodiment of the invention is shown in FIG. 9 and involves the inclusion of a separate heating element or coil. This embodiment is not preferred as the use of the two separate heating elements requires higher amperage and would require the rewiring of most buildings and the like. The use of a heating element or coil is optional.

As seen in FIG. 9, in the first housing (51), between the first motor (53), on the side to which the fan blade (77) is rotatably attached, and the nozzle passageway (59) running from the first housing is a first heating element (55) including coils. Likewise, in the second housing (52), between the second motor (54), on the side to which the fan blade (78) is rotatably attached, and the nozzle passageway (60) running from the second compartment is a second heating element (56) including coils. The first heating element (55) is secured to the inner wall (79) of the first housing (51). The second heating element (56) is secured to the inner wall (80) of the second housing (52). In each housing (51 and 52), the method of operation includes a fan (53 and 77, 54 and 78) pulling air into the body of the hot blower/dryer unit and driving it across an electric heating element (55 and 56) and out through a nozzle passageway (59 and 60). The air is pulled into both the first housing (51) and the second housing (52) through mesh (58) positioned across the top of each of the housing. An intake cap (85) is secured onto the air intake end of the first housing (51). Likewise, an intake cap (86) is secured onto the air intake end of the second housing (52).

Modifications and changes made to the hot-air blower/dryer can be effected without departing from the scope or spirit of the present invention. For example, a handle may or may not be attached to the top of the hot-air blower/dryer. Also, the embodiments of this hot-air blower/dryer, which are illustrated as follows, have been shown only by way of example and should not be taken to limit the scope of the following claims.

### LIST OF PARTS NUMBERS

In connection with the figures, the following list of the names of the parts of instant invention is noted:
50 hot blower/dryer unit;
51 first housing;
52 second housing;
53 first motor;
54 second motor;
55 first heating element including coils;
56 second heating element including coils;
57 exit passageway exhaust/end cap;
58 mesh;
59 nozzle passageway running from the first housing;
60 nozzle passageway from the second housing;
61 wire running from the left motor to the off side of the switch;
61 wire running from the right motor to the off side of the switch;
63 wire running from the power cord to the first switch;
64 jumper wire running between the first and second switches;
65 wire running from the left motor to the on side of the second switch;
66 wire running from the right motor to the on side of the first switch;
67 jumper wire running between the first switch and the second switch to the power light;
68 power cord to the light on the switch;
69 ground wire to the side of the unit;
70 service cord;
71 first switch;
72 second switch;
73 support for first housing;
74 support for second housing;
75 support securing the first motor to the inner wall of the first housing;
76 support securing the second motor to the inner wall of the second housing;
77 blade that is part of the first motor forming a fan;
78 blade that is part of the second motor forming a fan;
79 inner wall of the first housing;
80 inner wall of the second housing;
81 stands extending from the outer wall of the second housing;
82 outer wall of the first housing;
83 outer wall of the second housing;
84 cord running between the first motor and the second motor encasing wires;
85 intake cap on first housing;
86 intake cap on second housing;
87 cavity in the intake caps;
88 groove inside of exit passageway;
89 hot-air hose;
90 rim on end of hose;
91 exhaust/end cap;
92 exit cap;
93 exit cap;
94 opening on top of motor casing;
95 opening in panel between fan blade region and motor region;
96 motor casing;
97 gasket;
98 motor stop;
99 filter (screen);
40 fan;
41 fan blade;
42 copper windings;
43 spacer block;
44 bashing;
45 armature;
46 bearing.

What is claimed is:

1. A hot-air blower/dryer, which comprises:
a) a first inline hot-air blower, and
b) a second inline hot-air blower,
the first inline hot-air blower and the second inline hot-air blower being positioned side-by-side.

2. The hot-air blower/dryer as claimed in claim 1, wherein
a) the first inline hot-air blower includes a first housing having therein inline, a first motor, a first fan rotatably attached to the first motor, and a first heat coil, the first housing having an entrance aperture and an exit aperture;
b) the second inline hot-air blower includes a second housing, having therein inline, a second motor, a first fan rotatably attached and powered by the second motor, the second housing having an entrance aperture and an exit aperture; and
c) an exhaust end cap includes an exit passageway, a first entrance passageway in communication with the exit passageway and with the exit aperture of the first housing, and a second entrance passageway in communication with exit passageway and the exit aperture of the second housing.

3. The hot-air blower/dryer as claimed in claim 2 wherein the first inline hot-air blower and the second inline hot-air blower are in parallel alignment.

4. The hot-air blower/dryer as claimed in claim 3, wherein
(a) a first mesh is positioned over the entrance of the first housing; and
(b) a second mesh positioned over the entrance of the second housing.

5. The hot-air blower/dryer as claimed in claim 4, wherein the first inline hot-air blower and the second inline hot-air blower are mounted horizontally on a support.

6. The hot-air blower/dryer as claimed in claim 5, wherein the support has four casters.

7. The hot-air blower/dryer as claimed in claim 1, wherein the first inline hot-air blower and the second inline hot-air blower are mounted on a support.

8. The hot-air blower/dryer unit as claimed in claim 2, wherein exit passageway of the exhaust end cap has an exit end, and said exit end is adapted for attachment of a hot air hose thereto.

9. An exhaust end cap comprising: an exit passageway, a first entrance passageway having an entrance end and in communication with the exit passageway, a second entrance passageway having an entrance end in communication with the exit passageway, a first cap portion surrounding and extending away from the entrance end of the first entrance passageway, and asecond cap portion surrounding and extending away from the entrance end of the second entrance passageway.

10. The exhaust end cap as claimed in claim 9, wherein side of first cap portion away from the entrance end of the first entrance passageway has a concave shape, and side of second cap portion away from the entrance end of the second entrance passageway has a concave shape.

11. The exhaust end cap as claimed in claim 10, wherein the exit passageway of the exhaust end cap has an exit end, and said exit end is adapted for attachment of a hot-air hose thereto.

12. A method of using the hot-air blower/dryer as claimed in claim 1 for animal grooming, or drying grain, or farm application.
